(19) United States
(12) Patent Application Publication
(10) Pub. No.: US 2014/0222305 A1
(43) Pub. Date: Aug. 7, 2014

(54) DEVICE AND METHOD FOR REGULATING A DUAL-CLUTCH TRANSMISSION FOR ACHIEVING A SAFE STATE

(71) Applicants: Volker Nagele, Schonwald (DE); MIchael Pechtold, Furth (DE)

(72) Inventors: Volker Nagele, Schonwald (DE); MIchael Pechtold, Furth (DE)

(73) Assignee: CONTI TEMIC MICROELECTRONIC GMBH, Nurnberg (DE)

(21) Appl. No.: 13/985,593

(22) PCT Filed: Feb. 17, 2012
(86) PCT No.: PCT/DE2012/100038

§ 371 Date: Dec. 3, 2013

(30) Foreign Application Priority Data
Feb. 18, 2011 (DE) 10 2011 011 756.3

(51) Int. Cl. F16D 48/06

(52) U.S. Cl. CPC F16D 48/062; F16D 2500/304
USPC 701/68

(57) ABSTRACT

A device and method for regulating a hydraulically or electromechanically actuated dual-clutch transmission in a motor vehicle. A main computer selects a separate hardware unit in the emergency mode. A monitoring unit monitors the main computer and also selects the separate hardware unit in the emergency mode. At least one clutch is closed by spring force when in a depressurised state. A control unit controls a clutch actuator for actuating the clutch or for controlling a transmission actuator for providing different speeds of the dual-clutch transmission. In case of error, the safe state of an open drivetrain can be achieved by the separate hardware unit by the first control unit selecting the clutch actuator and the clutch actuator opening the at least one normally closed clutch, or by the second control unit selecting the hydraulic transmission actuator and the hydraulic transmission actuator placing the dual-clutch transmission in the neutral position.

### CROSS REFERENCE TO RELATED APPLICATIONS

This application is the U.S. National Phase Application of PCT/DE2012/100038, filed Feb. 17, 2012, which claims priority to German Patent Application No. 10 2011 011 756.3, filed Feb. 18, 2011, the contents of such applications being incorporated by reference herein.

### FIELD OF THE INVENTION

The invention relates to a device and a method for regulating a dual-clutch transmission according to the preambles of the independent claims.

### BACKGROUND OF THE INVENTION

There are different concepts for designing a control device, particularly for regulating a dual-clutch transmission in a motor vehicle, to be intrinsically safe. One way of achieving intrinsic safety of a control device is its monitoring in a 3-stage concept.

A method and a device for controlling a driving unit of a vehicle are known from DE 44 38 714 A1, which is incorporated by reference. Therein, the control device for power control has a computer element. The computer element performs both the control and monitoring of the correct functioning of the power control. Operational safety and availability are ensured by providing at least two stages independent of each other in a computer element for performing the control and monitoring, wherein the functions for power control are determined at a first stage, and these functions, and thus the functionality of the computer element itself, are monitored at a second stage, particularly in cooperation with a monitoring module.

In addition, DE 44 38 714 A1 describes a third stage which performs a sequence control of the second stage. This monitoring by the third stage increases the reliability and availability of the control device. Particularly in the monitoring module, the sequence control is executed as question-and-answer communication between monitoring module and computer element.

The 3-stage monitoring concept (EGAS concept) is increasingly accepted in control devices of vehicles for monitoring electronic systems. Therein, the control device consists of the so-called functional or main computer and the monitoring unit. Functional computer and monitoring unit communicate by way of a question-and-answer procedure. Furthermore, they have separate shut-off paths for the power determining output stages.

The EGAS concept was originally developed for engine control devices. There, stage 1 comprises the actual functional module for function control of the vehicle's driving unit. Therefore, it is also referred to as functional stage. It includes in particular engine control functions, including for implementing the requested engine torques, component monitoring, diagnosis of the input and output quantities, and control of the system reactions in a detected case of error. Stage 1 is executed on the functional computer.

Stage 2, also referred to as functional monitoring stage, comprises the safety module and is also executed on the functional computer. It detects the incorrect running of monitoring-related parts of the functional module of stage 1, including by monitoring the calculated torques or vehicle acceleration. In case of error, system reactions are triggered.

Stage 2 is performed in a hardware area of the functional computer which is secured by stage 3. Stage 3, also referred to as computer monitoring stage, comprises in particular the monitoring module on an independent monitoring computer with instruction set test, program sequence control, A/D converter test as well as cyclic and complete memory tests of stage 2. The monitoring module is executed on a monitoring computer. The monitoring computer which is independent of the functional computer tests the proper running of the program instructions of the functional computer by a question-and-answer procedure. In case of error, system reactions are triggered independently of the functional computer.

This monitoring concept can be used both in engine control devices and transmission control devices, particularly for mechanically intrinsically safe systems.

In a particular case, for a transmission having a clutch which is opened by a mechanical spring force when in a depressurised state, this means that the intended emergency state is achieved and the clutch is permanently kept in the open state by the mechanical spring force because the power determining output stages are shut off and the hydraulic system for actuating the clutch is no longer available. Thus, no torque is delivered any longer from the engine to the driving wheels.

However, there are transmission types in which the clutch is closed against a mechanical spring force when in a depressurised state, so-called “normally closed” clutches in which this monitoring concept cannot be used in this way.

### SUMMARY OF THE INVENTION

Therefore, an aspect of the invention is to create a simple, cost-effective and reliable device and a corresponding method for regulating a mechanically non-intrinsically safe system, in particular for a hydraulically actuated dual-clutch transmission.

The device for regulating a hydraulically actuated dual-clutch transmission in the drivetrain of a motor vehicle substantially comprises a main computer for regulating the normal mode of the vehicle which selects a separate hardware unit in the emergency mode, a monitoring unit for monitoring the main computer, a first hydraulic clutch for a first sub-transmission, a second hydraulic clutch for a second sub-transmission, wherein at least one clutch is closed by spring force when in a depressurised state, that is, is designed as a normally closed clutch, and a first and a second control unit for controlling a hydraulic clutch actuator for actuating the clutches, or for controlling a hydraulic transmission actuator for providing the different speeds of the dual-clutch transmission.

In case of error, the safe state of an open drivetrain can be achieved in particular by the separate hardware unit as follows: the separate hardware unit selects the clutch actuator by means of the first control unit and said clutch actuator opens the clutch, or the separate hardware unit selects the hydraulic transmission actuator by means of the second control unit and said hydraulic transmission actuator places the dual-clutch transmission in a neutral position, wherein the state of the open drivetrain can be achieved using hydraulic and electrical residual energy stored in the device, and wherein this state can be maintained without expending additional energy until the emergency mode is cancelled.

The hydraulic residual energy is stored in particular as residual pressure in a hydraulic accumulator of the device, wherein in the normal mode the pressure in the hydraulic accumulator is generated by a hydraulic pump.

The pressure in the hydraulic accumulator is detectable in particular by a pressure sensor, and, advantageously, the hydraulic pump can be switched on when the pressure falls below a lower pressure switching point and can be switched off when the pressure exceeds an upper pressure switching point.

In particular the lower switching point can be set such that in the emergency mode the hydraulic residual energy is sufficient to actuate the clutch actuator for opening the clutch or to actuate the transmission actuator for reaching the neutral position.

A method for regulating the hydraulically actuated, mechanically non-intrinsically safe dual-clutch transmission comprises in particular the following steps:
Detecting a safety-critical state by the main computer or by the monitoring unit and triggering the emergency mode,
Sending a control signal to the hardware unit by the main computer or by the monitoring unit,
Sending a control signal to the first control unit by the hardware unit,
Sending a control signal to the hydraulic clutch actuator by the first control unit,
Opening the at least one hydraulic normally closed clutch by the hydraulic clutch actuator,
Maintaining the open position of the hydraulic clutch actuator, with the normally closed clutch open, by means of a mechanical locking device or a hydraulic stop valve, wherein the sate of the open clutch is achieved using hydraulic and electrical residual energy stored in the device, and wherein this state is maintained without expending additional energy until the emergency mode is cancelled.

An alternative method for regulating the hydraulically actuated, mechanically non-intrinsically safe dual-clutch transmission comprises in particular the following steps:
Detecting a safety-critical state by the main computer or by the monitoring unit and triggering the emergency mode,
Sending a control signal to the hardware unit by the main computer or by the monitoring unit,
Sending a control signal to the second control unit by the hardware unit,
Sending a control signal to the hydraulic transmission actuator by the second control unit,
Adjusting and maintaining the neutral position in the dual-clutch transmission by the hydraulic transmission actuator, wherein the neutral position is achieved using hydraulic and electrical residual energy stored in the device, and wherein this state is maintained without expending additional energy until the emergency mode is cancelled.

Further, an aspect of the invention is to create a simple, cost-effective and reliable device and a corresponding method for regulating a mechanically non-intrinsically safe system, in particular for an electromechanically actuated dual-clutch transmission.

In case of error, the safe state of an open drivetrain can be achieved in particular by the separate hardware unit as follows: the separate hardware unit selects the clutch actuator by means of the appropriate control unit and said clutch actuator opens the clutch, or the separate hardware unit selects the electromechanical transmission actuator by means of the appropriate control unit and said electromechanical transmission actuator places the dual-clutch transmission in a neutral position, wherein the state of the open drivetrain can be achieved using electrical residual energy stored in the device, and wherein this state can be maintained without expending additional energy until the emergency mode is cancelled.

A method for regulating the electromechanically actuated, mechanically non-intrinsically safe dual-clutch transmission comprises in particular the following steps:
Detecting a safety-critical state by the main computer or by the monitoring unit and triggering the emergency mode,
Sending a control signal to the hardware unit by the main computer or by the monitoring unit,
Sending a control signal to the first control unit by the hardware unit,
Sending a control signal to the electromechanical clutch actuator by the first control unit,
Opening the at least one electromechanical normally closed clutch by the electromechanical clutch actuator,
Maintaining the open position of the electromechanical clutch actuator, with the clutch open, by means of a mechanical locking device or a hydraulic stop valve, wherein the state of the open clutch is achieved using electrical residual energy stored in the device, and wherein this state is maintained without expending additional energy until the emergency mode is cancelled.

An alternative method for regulating the electromechanically actuated, mechanically non-intrinsically safe dual-clutch transmission comprises in particular the following steps:
Detecting a safety-critical state by the main computer or by the monitoring unit and triggering the emergency mode,
Sending a control signal to the hardware unit by the main computer or by the monitoring unit,
Sending a control signal to the second control unit by the hardware unit,
Sending a control signal to the electromechanical transmission actuator by the second control unit,
Adjusting and maintaining the neutral position in the dual-clutch transmission by the electromechanical transmission actuator, wherein the neutral position is achieved using electrical residual energy stored in the device, and wherein this stated is maintained without expending additional energy until the emergency mode is cancelled.

In particular the electrical residual energy for supplying the control units and the electromechanical transmission actuator in the vehicle is stored in a separate electrical energy store or in the existing vehicle battery.

In the emergency mode, the clutch actuators can be maintained in this position, with the clutch open, for example by means of a mechanical locking device such as a spring-supported catch mechanism or a hydraulic stop valve.

Preferably the main computer, the monitoring unit, the separate hardware unit and the control units are arranged on a joint circuit carrier, allowing a compact design of the device.

Therein, in particular the separate hardware unit is designed as a discrete electronics for implementing a simple sequence control in the emergency mode, or it is designed as another computer for implementing a programmed sequence control in the emergency mode.

### BRIEF DESCRIPTION OF THE DRAWINGS

In the following description, the features and details of the invention will now be explained in more detail in connection with the accompanying drawings with reference to embodiments. The features and contexts described in individual variants are basically applicable to all embodiments. In the drawings:

FIG. 1 shows a schematic illustration of a device for regulating a dual-clutch transmission, and

FIGS. 2a-2c show schematic illustrations of a clutch actuator in the closed, open and in the open and energy-free fixed state.

### DETAILED DESCRIPTION OF THE INVENTION

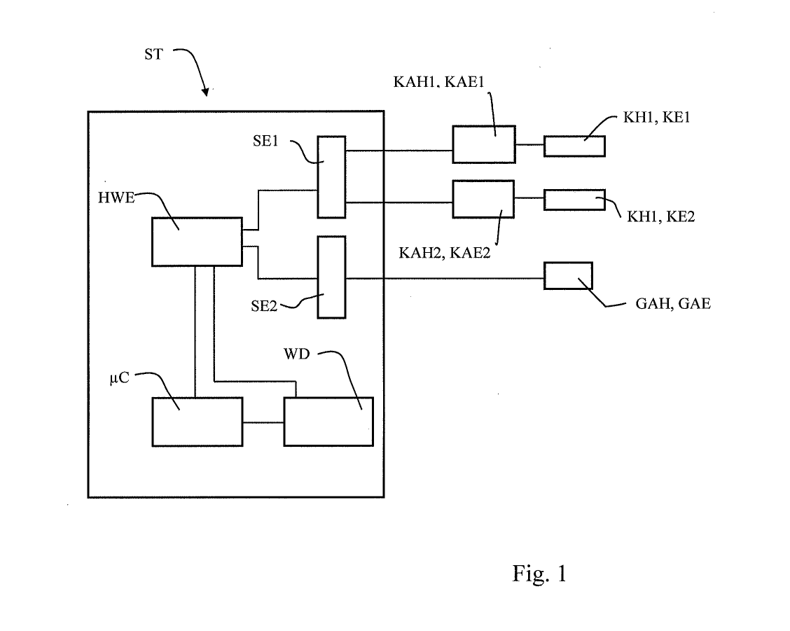

FIG. 1 shows a schematic illustration of a device for regulating a hydraulically actuated, non-illustrated dual-clutch transmission in the drivetrain of a motor vehicle. The device comprises a main computer μC for regulating the normal mode of the vehicle which can select a separate hardware unit HWE in the emergency mode, and a monitoring unit WD for monitoring the main computer μC which can also select a separate hardware unit HWE in the emergency mode. Furthermore, the device comprises a first hydraulically actuated clutch KH1 for a first sub-transmission, a second hydraulically actuated clutch KH2 for a second sub-transmission, wherein at least one clutch KH1, KH2 is closed by spring force when in a depressurised state.

Furthermore, the device comprises a first control unit SE1 for controlling a first hydraulic clutch actuator KAH1 and a second hydraulic clutch actuator KAH2 for actuating the first clutch KH1 or the second clutch KH2, and a second control unit SE2 for controlling a hydraulic transmission actuator GAH for providing the different speeds of the dual-clutch transmission.

Advantageously, the main computer μC, the separate hardware unit HWE, the monitoring unit WD and the first and the second control unit SE1, SE2 are arranged on a joint circuit carrier ST. Above all, this allows a compact design of the device.

The monitoring unit WD monitors in particular the function of the main computer μC which in turn controls the normal mode of the vehicle. In case of error, the main computer μC triggers the emergency mode and then selects the hardware unit HWE. It would also be conceivable that the emergency mode is triggered by the monitoring unit WD, e.g. in case of failure of the main computer μC.

In case of error, the safe state of an open drivetrain is achieved in particular by the separate hardware unit HWE. There are two options. One option is that the separate hardware unit HWE selects the hydraulic clutch actuators KAH1, KAH2 by means of the first control unit SE1 and these actuators KAH1, KAH2 open the corresponding hydraulic clutches KH1, KH2 if both clutches KH1, KH2 are designed as normally closed clutches.

The second option is that the separate hardware unit HWE selects the hydraulic transmission actuator GAH by means of the second control unit SE2 and said hydraulic transmission actuator places the dual-clutch transmission in a neutral position. It is particularly advantageous that the state of the open drivetrain can be achieved using hydraulic and/or electrical residual energy stored in the device. An additional advantage is that this state of the open drivetrain can be maintained without expending additional energy until the emergency mode is cancelled.

So far, a device for regulating a hydraulically actuated dual-clutch transmission has been described in FIG. 1. Of course, what was said also applies to a device for regulating an electromechanically actuated dual-clutch transmission having electromechanical clutch actuators KAE1, KAE2 for actuating the electromechanical clutches KE1, KE2 and having an electromechanical transmission actuator GAE.

The hydraulic residual energy stored in the device can be stored in particular as residual pressure in a hydraulic accumulator of the device, wherein in the normal mode the pressure in the hydraulic accumulator is generally generated by a hydraulic pump.

The electrical residual energy stored in the device for supplying the control unit SE1, SE2, the electromechanical clutch actuators KAE1, KAE2 and the electromechanical transmission actuator GAE is stored in particular in a separate electrical energy store, e.g. a capacitor in the vehicle or the existent vehicle battery.

An additional advantage is that in the emergency mode in particular the state of the open drivetrain can be maintained in this position by the open clutches KH1, KE1, KH2, KE2 without expending additional energy until the emergency mode is cancelled, wherein the clutch actuators KAH1, KAH2, KAE1, KAE2 are fixed in this position in particular by means of a mechanical locking device VVR or a hydraulic stop valve.

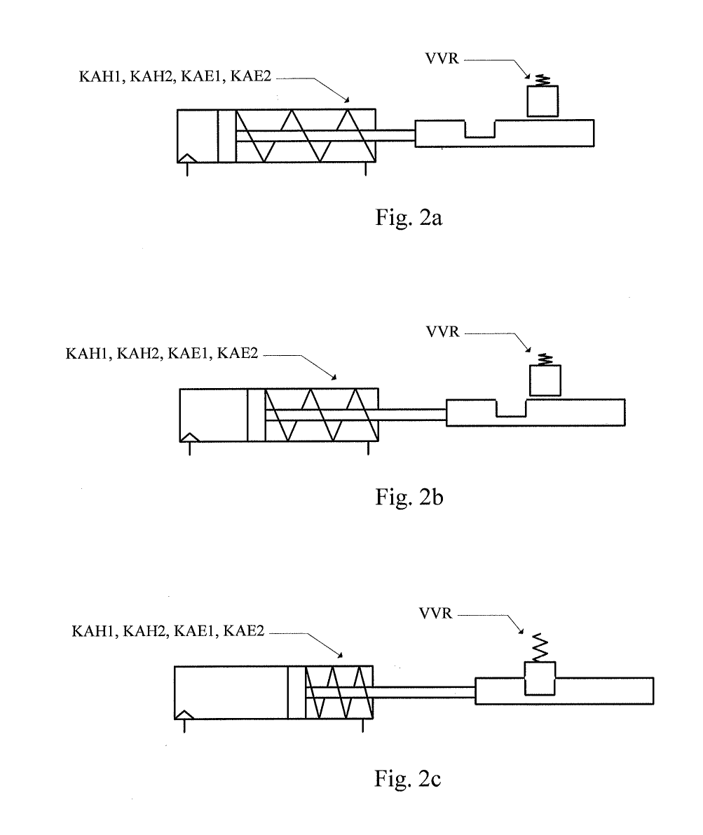

FIG. 2a, FIG. 2b and FIG. 2c show a schematic illustration of a clutch actuator KAH1, KAH2, KAE1, KAE2 in the closed, open and in the open and additionally energy-free fixed or powerless arrested state. In this case, the energy-free fixing or powerless arresting of the clutch actuator KAH1, KAH2, KAE1, KAE2 in the “open” state is illustrated by a mechanical, spring-supported catch. This state could also be achieved for example by a suitable hydraulic stop valve instead of the mechanical catch.

After achieving the “open” clutch position, the clutch KH1, KE1, KH2, KE2 is prevented form leaving the “open” position in an energy-free way.

In order to cancel the fixing of the safe state, the fixing must be released by expending energy after a successful availability check of the system by the main computer.

This happens for example by the following sequence, with the normally closed clutch fixed and open:
Moving the clutch actuator in the “open clutch” direction to resume the clutch position,
Releasing the fixing e.g. by electromagnetically retracting the mechanical locking or catching or electrically opening the hydraulic stop valve,
Moving the clutch in the specified position of the control unit working again in correct the normal mode of the vehicle.

In summary, it can be said that the device according to the invention has the following advantages:
Utilizing the stored residual energy from energy stores which are present in the system, such as capacitors or hydraulic accumulators,
Fixing the safe state of the open clutches without further expenditure of energy, such as energization of valves and pump motors,
Eliminating the need for any actively controlling systems for maintaining the safe state of the system, such as computer units, hydraulic units, and
Possibility of using a “normally closed” clutch in automated transmissions and thus of reducing energy consumption of the vehicle even in the normal mode in the event that the active normally closed clutch is closed without energy expenditure and the second clutch which is inactive at the same time is open against a spring force, also without additional expenditure of energy.
In a case of application where two normally closed clutches are used in a dual-clutch transmission, the energy saving advantage of using only one normally closed clutch is at least partially lost, since in the normal mode, one normally closed clutch must always be opened and held open by overcoming the spring force expending energy. This can be counteracted by ensuring that the opening of the inactive normally closed clutch and the holding open of this clutch in the normal mode is done on the same principle as in case of error.

1-15. (canceled)

16. A device for regulating a hydraulically actuated, mechanically non-intrinsically safe dual-clutch transmission in the drivetrain of a motor vehicle, comprising:
a main computer for regulating the normal mode of the vehicle which can select a separate hardware unit in the emergency mode;
a monitoring unit for monitoring the main computer, wherein the monitoring unit can select the separate hardware unit in the emergency mode;
a first hydraulic clutch for a first sub-transmission, a second hydraulic clutch for a second sub-transmission, wherein at least one of the first clutch and the second clutch is closed by a spring force when in a depressurised state; and
a control unit for controlling a hydraulic clutch actuator for actuating the corresponding clutch, or for controlling a hydraulic transmission actuator for providing the different speeds of the dual-clutch transmission;
wherein in case of error, a safe state of an open drivetrain can be achieved by the separate hardware unit as follows:
the separate hardware unit selects the clutch actuator by the first control unit and said clutch actuator opens the at least one normally closed clutch, or
the separate hardware unit selects the hydraulic transmission actuator by the second control unit and said hydraulic transmission actuator places the dual-clutch transmission in a neutral position, and
wherein the state of the open drivetrain can be achieved using hydraulic and/or electrical residual energy stored in the device, and wherein this state can be maintained without expending additional energy until the emergency mode is cancelled.

17. A device according to claim 16, wherein the hydraulic residual energy is stored as residual pressure in a hydraulic accumulator of the device, and wherein in the normal mode the pressure is generated in the hydraulic accumulator by a hydraulic pump.

18. A device according to claim 16, wherein the pressure in the hydraulic accumulator can be detected by a pressure sensor, and the hydraulic pump can be switched on when the pressure falls below a lower switching point and can be switched off when the pressures exceeds an upper switching point.

19. A device according to claim 18, wherein the lower switching point can be set such that in the emergency mode the hydraulic residual energy is sufficient to actuate the clutch actuator for opening the clutch or the transmission actuator for achieving the neutral position.

20. A method for regulating a hydraulically actuated, mechanically non-intrinsically safe dual-clutch transmission having a device according to claim 16, comprising:
detecting a safety-critical state by the main computer or by the monitoring unit and triggering the emergency mode by the main computer or by the monitoring unit;
sending a control signal to the hardware unit by the main computer or by the monitoring unit;
sending a control signal to the first control unit by the hardware unit;
sending a control signal to the hydraulic clutch actuator by the first control unit;
opening the at least one hydraulic normally closed clutch by the hydraulic clutch actuator; and
maintaining the open position of the hydraulic clutch actuator, with the normally closed clutch open, by a mechanical locking device or a hydraulic stop valve, wherein the state of the open normally closed clutch is achieved using hydraulic and electrical residual energy stored in the device, and wherein this state is maintained without expending additional energy until the emergency mode is cancelled.

21. A control device for use in a method according to claim 20.

22. A method for regulating a hydraulically actuated, mechanically non-intrinsically safe dual-clutch transmission having a device according to claim 16, comprising:
detecting a safety-critical state by the main computer or by the monitoring unit and triggering the emergency mode by the main computer or by the monitoring unit;
sending a control signal to the hardware unit by the main computer or by the monitoring unit;
sending a control signal a second control unit by the hardware unit;
sending a control signal an hydraulic transmission actuator by the second control unit; and
adjusting and maintaining the neutral position in the dual-clutch transmission by the hydraulic transmission actuator, wherein the neutral position is achieved using hydraulic and electrical residual energy stored in the device, and wherein this state is maintained without expending additional energy until the emergency mode is cancelled.

23. A control device for use in a method according to claim 22.

24. A device according to 23, wherein the electrical residual energy for supplying the control unit and of the electromechanical transmission actuator is stored in a separate electrical energy store in the vehicle or the vehicle battery.

25. A device according to claim 23, wherein the clutch actuator can be held in position, with the clutch open, by a mechanical locking device or a hydraulic stop valve.

26. A device according to claim 23, wherein the main computer, the monitoring unit, the separate hardware unit and the control unit are arranged on a joint circuit carrier.

27. A device according to claim 23, wherein the separate hardware unit is designed as a discrete electronics for implementing a simple sequence control in the emergency mode or is designed as another computer for implementing a programmed sequence control in the emergency mode.

28. A device according to claim 16, wherein the electrical residual energy for supplying the control unit and of the electromechanical transmission actuator is stored in a separate electrical energy store in the vehicle or the vehicle battery.

29. A device according to claim 16, wherein the clutch actuator can be held in position, with the clutch open, by a mechanical locking device or a hydraulic stop valve.

30. A device according to claim 16, wherein the main computer, the monitoring unit, the separate hardware unit and the control unit are arranged on a joint circuit carrier.

31. A device according to claim 16, wherein the separate hardware unit is designed as a discrete electronics for implementing a simple sequence control in the emergency mode or is designed as another computer for implementing a programmed sequence control in the emergency mode.

32. A device for regulating an electromechanically actuated, mechanically non-intrinsically safe dual-clutch transmission in the drivetrain of a motor vehicle, comprising:
a main computer for regulating the normal mode of the vehicle which can select a separate hardware unit in an emergency mode;
a monitoring unit for monitoring the main computer, wherein the monitoring unit can select the separate hardware unit in the emergency mode;
a first electromechanical clutch for a first sub-transmission, a second electromechanical clutch for a second sub-transmission, wherein at least one clutch is closed by a spring force in the currentless state; and
a control unit for controlling an electromechanical clutch actuator for actuating the clutch, or for controlling a electromechanical transmission actuator for providing the different speeds of the dual-clutch transmission,
wherein in case of error, the safe state of the open drivetrain can be achieved by the separate hardware unit as follows:
the separate hardware unit selects the clutch actuator by the first control unit and said clutch actuator opens the at least one normally closed clutch, or
the separate hardware unit selects the electromechanical transmission actuator by the second control unit and said electromechanical transmission actuator places the dual-clutch transmission in a neutral position, wherein the state of the open drivetrain can be achieved using electrical residual energy stored in the device, and wherein this state is maintained without expending additional energy until the emergency mode is cancelled.

33. A method for regulating an electromechanically actuated, mechanically non-intrinsically safe dual-clutch transmission having a device according to claim 23, comprising:
detecting a safety-critical state by the main computer or by the monitoring unit and triggering the emergency mode by the main computer or by the monitoring unit;
sending a control signal to the hardware unit by the main computer or by the monitoring unit, sending a control signal to the first control unit by the hardware unit;
sending a control signal to the electromechanical clutch actuator by the first control unit,
opening the at least one electromechanical normally closed clutch by the electromechanical clutch actuator; and
maintaining the open position of the electromechanical clutch actuator, with the normally closed clutch open, by a mechanical locking device or a hydraulic stop valve, wherein the state of the open clutch is achieved using electrical residual energy stored in the device, and wherein this state is maintained without expending additional energy until the emergency mode is cancelled.

34. A control device for use in a method according to claim 33.

35. A method for regulating an electromechanically actuated, mechanically non-intrinsically safe dual-clutch transmission having a device according to claim 23, comprising:
detecting a safety-critical state by the main computer or by the monitoring unit and triggering the emergency mode by the main computer or by the monitoring unit;
sending a control signal to the hardware unit by the main computer or by the monitoring unit;
sending a control signal to the second control unit by the hardware unit;
sending a control signal to the electromechanical transmission actuator by the second control unit); and
adjusting and maintaining the neutral position in the dual-clutch transmission by the electromechanical transmission actuator, wherein the neutral position is achieved using electrical residual energy stored in the device, and wherein this state is maintained without expending additional energy until the emergency mode is cancelled.

36. A control device for use in a method according to claim 35.
